(19) United States
(12) Patent Application Publication
(10) Pub. No.: US 2004/0008775 A1
(43) Pub. Date: Jan. 15, 2004

(54) Method of managing reference frame and field buffers in adaptive frame/field encoding

(76) Inventors: Krit Panusopone, San Diego, CA (US); Limin Wang, San Diego, CA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/290,843

(22) Filed: Nov. 7, 2002

Related U.S. Application Data
(60) Provisional application No. 60/395,735, filed on Jul. 12, 2002.

(51) Int. Cl. H04N 7/12

(52) U.S. Cl. 375/240.12

(57) ABSTRACT

A method and encoder for managing a frame buffer and a field buffer for temporal prediction with motion compensation with multiple reference pictures in adaptive frame/field encoding of digital video content. The encoder comprises the frame buffer and the field buffer. The digital video content comprises a stream of pictures. The pictures can each be intra, predicted, or bidirectionally interpolated pictures.

### RELATED APPLICATION

The present application is related to and claims priority under 35 U.S.C. §119(e) from U.S. Provisional Patent Application No. 60/395,735, filed Jul. 12, 2002 and incorporated herein by reference in its entirety.

### FIELD OF THE INVENTION

The present invention generally relates to digital video encoding and compression. More specifically, the present invention relates to reference frame and field buffer management in adaptive frame/field encoding as used in the Joint Video Team video encoding standard.

### BACKGROUND OF THE INVENTION

Video compression is used in many current and emerging products. It is at the heart of digital television set-top boxes (STBs), digital satellite systems (DSSs), high definition television (HDTV) decoders, digital versatile disk (DVD) players, video conferencing, Internet video and multimedia content, and other digital video applications. Without video compression, digital video content can be extremely large, making it difficult or even impossible to efficiently store, transmit, or view the digital video content.

The digital video content comprises a stream of pictures that can be displayed on a television receiver, computer monitor, or some other electronic device capable of displaying digital video content. A picture that is displayed in time before a particular picture is in the “backward direction” in relation to the particular picture. Likewise, a picture that is displayed in time after a particular picture is in the “forward direction” in relation to the particular picture.

Video compression is accomplished in a video encoding, or coding, process in which each picture is encoded as either a frame or as two fields. Each frame comprises a number of lines of spatial information. For example, a typical frame contains 525 horizontal lines. Each field contains half the number of lines in the frame. For example, if the frame comprises 525 horizontal lines, each field comprises 262.5 horizontal lines. In a typical configuration, one of the fields comprises the odd numbered lines in the frame and the other field comprises the even numbered lines in the frame. The two fields can be interlaced together to form the frame.

The general idea behind video coding is to remove data from the digital video content that is “non-essential.” The decreased amount of data then requires less bandwidth for broadcast or transmission. After the compressed video data has been transmitted, it must be decoded, or decompressed. In this process, the transmitted video data is processed to generate approximation data that is substituted into the video data to replace the “non-essential” data that was removed in the coding process.

Video coding transforms the digital video content into a compressed form that can be stored using less space and transmitted using less bandwidth than uncompressed digital video content. It does so by taking advantage of temporal and spatial redundancies in the pictures of the video content. The digital video content can be stored in a storage medium such as a hard drive, DVD, or some other non-volatile storage unit.

There are numerous video coding methods that compress the digital video content. Consequently, video coding standards have been developed to standardize the various video coding methods so that the compressed digital video content is rendered in formats that a majority of video encoders and decoders can recognize. For example, the Motion Picture Experts Group (MPEG) and International Telecommunication Union (ITU-T) have developed video coding standards that are in wide use. Examples of these standards include the MPEG-1, MPEG-2, MPEG-4, ITU-T H261, and ITU-T H263 standards.

Most modern video coding standards, such as those developed by MPEG and ITU-T, are based in part on a temporal prediction with motion compensation (MC) algorithm. Temporal prediction with motion compensation is used to remove temporal redundancy between successive pictures in a digital video broadcast. The algorithm is software-based and is executed by an encoder.

The temporal prediction with motion compensation algorithm typically utilizes one or two reference pictures to encode a particular picture. A reference picture is a picture that has already been encoded. By comparing the particular picture that is to be encoded with one of the reference pictures, the temporal prediction with motion compensation algorithm can take advantage of the temporal redundancy that exists between the reference picture and the particular picture that is to be encoded and encode the picture with a higher amount of compression than if the picture were encoded without using the temporal prediction with motion compensation algorithm. One of the reference pictures is in the backward direction in relation to the particular picture that is to be encoded. The other reference picture is in the forward direction in relation to the particular picture that is to be encoded.

The encoder stores the reference pictures that are used to encode the particular picture in buffers. A frame buffer capable of storing two frames is used to store the reference pictures encoded as frames. In addition, a field buffer capable of storing four fields is used to store the reference pictures encoded as fields.

However, as the demand for higher resolutions, more complex graphical content, and faster transmission time increases, so does the need for better video compression methods. To this end, a new video coding standard is currently being developed. This new video coding standard is called the Joint Video Team (JVT) standard. The JVT standard combines techniques from both MPEG and ITU-T.

One of the features of the new JVT video coding standard is that it allows multiple reference pictures, instead of just two reference pictures. The use of multiple reference pictures improves the performance of the temporal prediction with motion compensation algorithm by allowing the encoder to find the reference picture that most closely matches the picture that is to be encoded. By using the reference picture in the coding process that most closely matches the picture that is to be encoded, the greatest amount of compression is possible in the encoding of the picture.

With multiple reference pictures, the frame and field buffers must be capable of holding a varying number of reference frames and reference fields, respectively. Therefore, the reference frame and field buffers can be large and complex. Thus, there is a need in the art for a standard method of reference frame and field buffer management for temporal prediction with motion compensation using multiple reference frames or fields. Because multiple reference frames or fields have never been included in a video coding standard, there are currently no solutions to the need for a standard method of reference frame and field buffer management for temporal prediction with motion compensation using multiple reference frames or fields.

### SUMMARY OF THE INVENTION

In one of many possible embodiments, the present invention provides a method and of managing a frame buffer and a field buffer for temporal prediction with motion compensation with multiple reference pictures in adaptive frame/field encoding of digital video content and an encoder that enables the method to be executed. The encoder comprises the frame buffer and the field buffer. The digital video content comprises a stream of pictures. The pictures can each be intra or predicted pictures. The method comprises, for each successive picture in the stream, a number of steps. First, each successive picture is encoded as a frame and as a first and a second field resulting in an encoded frame and an encoded first field and an encoded second field. Next, the contents of a reference position n (mref[n]) of the frame buffer are replaced with contents of a reference position n-1 (mref[n-1]) of the frame buffer. The contents of mref[n] and mref[n-1] of the frame buffer comprise reference frames. The encoded frame is then stored in a reference position 0 (mref[0]) of the frame buffer. The contents of mref[n] of the field buffer are replaced with contents of mref[n-1] of the field buffer after the encoding of the first field and before the encoding of the second field. The contents of mref[n] and mref[n-1] of the field buffer comprise the reference fields. The encoded first field is then stored in mref[0] of the field buffer. The contents of mref[n] of the field buffer are replaced with the contents of mref[n-1] of the field buffer after the encoding of the second field. The encoded second field is stored in mref[0] of the field buffer. Next, a next picture encoding mode is determined if another picture in the stream of pictures is to be encoded. The next picture encoding mode is either the frame coding mode or the field coding mode. The encoded frame in mref[0] of the frame buffer is replaced with a reconstructed frame that is reconstructed from the encoded first field and the encoded second field if the next picture encoding mode is field coding mode. However, the encoded first field in a reference position 1 (mref[1]) of the field buffer is replaced with a reconstructed first field and the encoded second field of mref[0] of the field buffer is replaced with a reconstructed second field if the next picture encoding mode is frame coding mode. The reconstructed first and second fields are reconstructed from the encoded frame.

Another embodiment of the present invention provides a method of managing a frame buffer and a field buffer for temporal prediction with motion compensation with multiple reference pictures in adaptive frame/field encoding of digital video content and an encoder that enables the method to be executed. The encoder comprises the frame buffer and the field buffer. The digital video content comprises a stream of pictures which can each be intra, predicted, or bidirectionally interpolated pictures. The method comprises, for each successive intra or predicted picture in the stream, a number of steps. First, the contents of a reference position n (mref[n]) of the frame buffer are replaced with contents of a reference position n-1 (mref[n-1]) of the frame buffer. Content of an additional reference position (mref_P) of the frame buffer is copied into a reference position 0 (mref[0]) of the frame buffer. The contents of mref[n] of the field buffer are replaced with contents of mref[n-1] of the field buffer. Content of an additional reference top field position (mref_P_top) of the field buffer is copied into mref[0] of the field buffer. Each successive picture is then encoded as a frame and as a first and a second field resulting in an encoded frame and an encoded first field and an encoded second field. The encoded frame is stored in mref_P of the frame buffer. The encoded first field is stored in mref_P_top of the field buffer. The contents of mref[n] of the field buffer are replaced with the contents of mref[n-1] of the field buffer after the encoding of the first field and before the encoding of the second field. The content of an additional reference bottom field position (mref_P_bot) of the field buffer is copied into mref[0] of the field buffer. The encoded second field is stored in mref_P_bot of the field buffer. A next picture encoding mode is determined if another picture in the stream of pictures is to be encode. The next picture encoding mode is either a frame coding mode or a field coding mode. The content of mref_P of the frame buffer is replaced with a reconstructed frame that is reconstructed from the encoded first field and the encoded second field if the next picture encoding mode is field coding mode. The content of mref[0] of the field buffer is replaced with a reconstructed first field if the next picture encoding mode is frame coding mode. The reconstructed first field is reconstructed from the encoded frame. The contents of mref_P_top and mref_P_bot are replaced with the reconstructed first field and a reconstructed second field, respectively, if the next picture encoding mode is frame coding mode. The reconstructed second field is reconstructed from the encoded frame. No modifications are made to the frame buffer or to the field buffer when each successive bidirectionally interpolated picture in the stream is encoded as the frame or as the first field and the second field.

Another embodiment of the present invention provides a method of managing a frame buffer for the storage of only bidirectionally interpolated pictures that are encoded as frames and a field buffer the storage of only bidirectionally interpolated pictures that are encoded as fields. The method is also for temporal prediction with motion compensation with multiple reference pictures in adaptive frame/field encoding of digital video content and further entails an encoder that enables the method to be executed.

Additional advantages and novel features of the invention will be set forth in the description which follows or may be learned by those skilled in the art through reading these materials or practicing the invention. The advantages of the invention may be achieved through the means recited in the attached claims.

### BRIEF DESCRIPTION OF THE DRAWINGS

The accompanying drawings illustrate various embodiments of the present invention and are a part of the specification. Together with the following description, the drawings demonstrate and explain the principles of the present invention. The illustrated embodiments are examples of the present invention and do not limit the scope of the invention.

FIG. 1 illustrates an exemplary sequence of three types of pictures according to an embodiment of the present invention, as defined by an exemplary video coding standard such as the JVT standard.

FIG. 2 shows a picture construction example using temporal prediction with motion compensation that illustrates an embodiment of the present invention.

FIG. 3 shows an exemplary stream of pictures, which illustrates an advantage of using multiple reference pictures in temporal prediction with motion compensation according to an embodiment of the present invention.

FIG. 4 is a flow chart illustrating a method of reference frame and field buffer management with multiple reference pictures in the adaptive frame/field encoding of digital video content comprising a stream of I and P pictures according to an embodiment of the present invention.

FIG. 5 illustrates a detailed procedure for frame buffer management without B pictures according to an embodiment of the present invention.

FIG. 6 illustrates a detailed procedure for frame buffer management with B pictures that are to be encoded as frames and stored in a B frame buffer according to an embodiment of the present invention.

FIG. 7 illustrates a detailed procedure for field buffer management without B pictures according to an embodiment of the present invention.

FIG. 8 and FIG. 9 illustrate a detailed procedure for field buffer management with B pictures that are to be encoded as fields and stored in a B field buffer according to an embodiment of the present invention.

FIG. 10 illustrates a detailed procedure for frame buffer management with B pictures and where the B pictures that are encoded as frames are stored in the same frame buffer as the I and P pictures that are encoded as frames according to an embodiment of the present invention.

FIG. 11 illustrates a detailed procedure for field buffer management with B pictures and where the B pictures that are encoded as fields are stored in the same field buffer as the I and P pictures that are encoded as fields according to an embodiment of the present invention.

FIG. 12 shows an example of frame buffer management without B pictures as described in connection with FIG. 5.

FIG. 13 shows an example of frame buffer management including B pictures where the encoded B pictures are stored in the same frame buffer as are the encoded I and P pictures, as described in connection with FIG. 10.

FIG. 14 shows an example of field buffer management without B pictures as described in connection with FIG. 7.

FIG. 15 shows an example of field buffer management with B pictures as described in connection with FIG. 11.

Throughout the drawings, identical reference numbers designate similar, but not necessarily identical, elements.

### DETAILED DESCRIPTION OF THE PREFERRED EMBODIMENTS

The present invention provides a method of frame buffer and field buffer management for temporal prediction with motion compensation with multiple reference pictures in the adaptive frame/field encoding of digital video content comprising a stream of pictures. The method also applies to frame and field buffer management in the decoding of encoded pictures.

As noted above, the JVT standard is a new standard for encoding and compressing digital video content. The documents establishing the JVT standard are hereby incorporated by reference, including “Joint Final Committee Draft (JFCD) of Joint Video Specification” issued by the JVT on Aug. 10, 2002. (ITU-T Rec. H.264 & ISO/IEC 14496-10 AVC). Due to the public nature of the JVT standard, the present specification will not attempt to document all the existing aspects of JVT video coding, relying instead on the incorporated specifications of the standard.

Although this method is compatible with and will be explained using the JVT standard guidelines, it can be modified and used to handle any buffer structure of multiple reference frames as best serves a particular standard or application.

Using the drawings, the preferred embodiments of the present invention will now be explained.

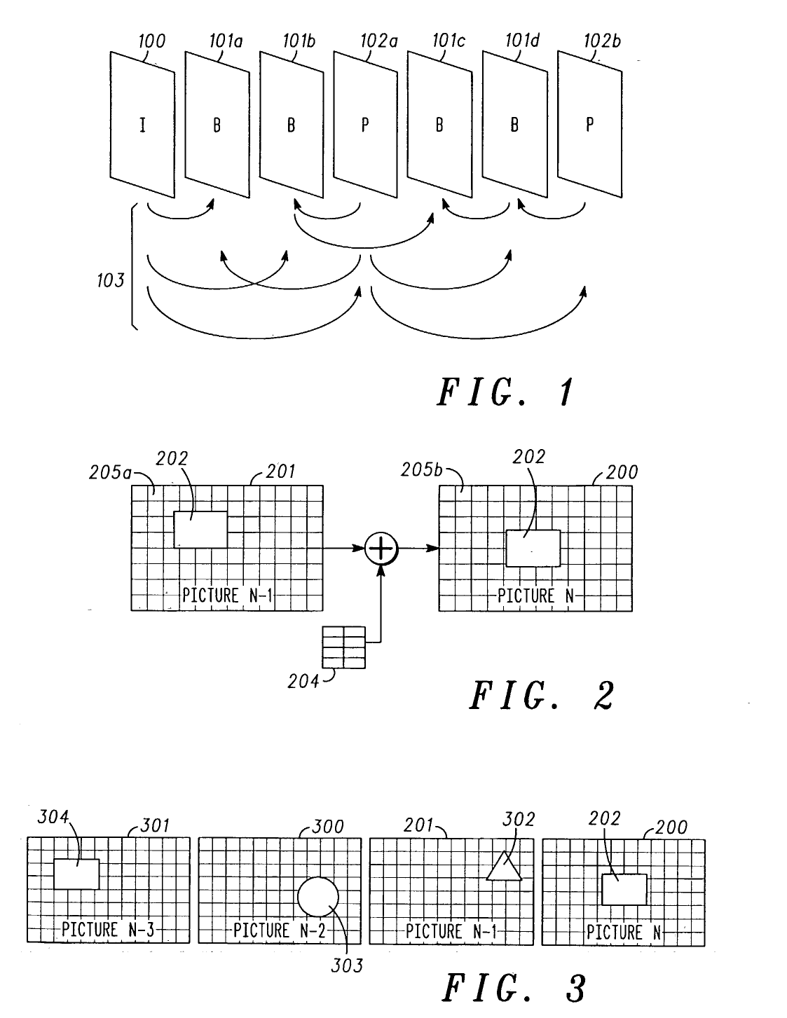

FIG. 1 illustrates an exemplary sequence of three types of pictures that can be used to implement the present invention, as defined by an exemplary video coding standard such as the JVT standard. As previously mentioned, the encoder encodes the pictures. The encoder can be a processor, application specific integrated circuit (ASIC), field programmable gate array (FPGA), coder/decoder (CODEC), digital signal processor (DSP), or some other electronic device that is capable of encoding the stream of pictures. However, as used hereafter and in the appended claims, unless otherwise specifically denoted, the term “encoder” will be used to refer expansively to all electronic devices that encode digital video content comprising a stream of pictures.

As shown in FIG. 1, there are preferably three types of pictures that can be used in the video coding method. Three types of pictures are defined to support random access to stored digital video content while exploring the maximum redundancy reduction using temporal prediction with motion compensation. The three types of pictures are intra (I) pictures (100), predicted (P) pictures (102a,b), and bidirectionally interpolated (B) pictures (101a-d). An I picture (100) provides an access point for random access to stored digital video content and can be encoded only with slight compression. Intra pictures (100) are encoded without referring to reference pictures.

A predicted picture (102a,b) is encoded using an I or P picture that has already been encoded as a reference picture. The reference picture can be in either the forward or backward temporal direction in relation to the P picture that is being encoded. The predicted pictures (102a,b) can be encoded with more compression than the intra pictures (100).

A bidirectionally interpolated picture (101a-d) is encoded using two temporal reference pictures: a forward reference picture and a backward reference picture. An embodiment of the present invention is that the forward reference picture and backward reference picture can be in the same temporal direction in relation to the B picture that is being encoded. Bidirectionally interpolated pictures (101a-d) can be encoded with the most compression out of the three picture types.

Reference relationships (103) between the three picture types are illustrated in FIG. 1. For example, the P picture (102a) can be encoded using the encoded I picture (100) as its reference picture. The B pictures (101a-d) can be encoded using the encoded I picture (100) and the encoded P picture (102a) as its reference pictures, as shown in FIG. 1. Under the principles of an embodiment of the present invention, encoded B pictures (101a-d) can also be used as reference pictures for other B pictures that are to be encoded. For example, the B picture (101c) of FIG. 1 is shown with two other B pictures (101b and 101d) as its reference pictures.

The number and particular order of the I (100), B (101a-d), and P (102a,b) pictures shown in FIG. 1 are given as an exemplary configuration of pictures, but are not necessary to implement the present invention. Any number of I, B, and P pictures can be used in any order to best serve a particular application. The JVT standard does not impose any limit to the number of B pictures between two reference pictures nor does it limit the number of pictures between two I pictures.

FIG. 2 shows a picture construction example using temporal prediction with motion compensation that illustrates an embodiment of the present invention. Temporal prediction with motion compensation assumes that a current picture, picture N (200), can be locally modeled as a translation of another picture, picture N-1 (201). The picture N-1 (201) is the reference picture for the encoding of picture N (200) and can be in the forward or backwards temporal direction in relation to picture N (200).

As shown in FIG. 2, each picture is preferably divided into macroblocks (205a,b). A macroblock (205a,b) is a rectangular group of pixels. For example, a typical macroblock (205a,b) size is 16 by 16 pixels.

As shown in FIG. 2, the picture N-1 (201) contains an image (202) that is to be shown in picture N (200). The image (202) will be in a different temporal position in picture N (200) than it is in picture N-1 (201), as shown in FIG. 2. The image content of each macroblock (205b) of picture N (200) is predicted from the image content of each corresponding macroblock (205a) of picture N-1 (201) by estimating the required amount of temporal motion of the image content of each macroblock (205a) of picture N-1 (201) for the image (202) to move to its new temporal position in picture N (200).

The temporal prediction with motion compensation algorithm generates motion vectors that represent the amount of temporal motion required for the image (202) to move to a new temporal position in the picture N (200). Although the JVT standard specifies how to represent the motion information for the image contents of each macroblock (205a,b), it does not, however, specify how such motion vectors are to be computed. Many implementations of motion vector computation use block-matching techniques, where the motion vector is obtained by minimizing a cost function measuring the mismatch between a macroblock from the reference picture, picture N-1 (201), and a macroblock from the picture N (200). Although any cost function can be used, the most widely-used choice is the absolute difference (AE) defined as:

$$AE ( {d}_{x} {d}_{y} ) = {\sum }_{i = 0}^{15} {\sum }_{j = 0}^{15} \vert f ( i , j ) - g ( i - {d}_{x} , j - {d}_{y} ) \vert \qquad \text{(Eq. 1)}$$

In Eq. 1, f(i, j) represents a particular 16 by 16 pixel macroblock from the current picture N (200), and g(i, j) represents the same macroblock from the reference picture, picture N-1 (201). The reference picture's macroblock is displaced by a vector (dₓ, d_{y}), representing a search location. The AE is preferably calculated at several locations to find the best matching macroblock which produces a minimum mismatch error. The AE value is preferably expressed in pixels or fractions of pixels.

The motion vectors are represented by a motion vector table (204) in FIG. 2. The motion vectors in the motion vector table (204) are used by the temporal prediction with motion compensation algorithm to encode the picture N (200). FIG. 2 shows that the motion vectors in the motion vector table (204) are combined with information contained in the picture N-1 (201) to encode the picture N (200). The exact method of encoding using the motion vectors can vary as best serves a particular application and can be easily implemented by someone who is skilled in the art.

FIG. 3 shows an exemplary stream of pictures which illustrates an advantage of using multiple reference pictures in temporal prediction with motion compensation according to an embodiment of the present invention. The use of multiple reference pictures increases the likelihood that Eq. 1 will yield motion vectors that allow the picture N (200) to be encoded with the most compression possible. Pictures N-1 (201), N-2 (300), and N-3 (301) have been already encoded in this example. As shown in FIG. 3, an image (304) in picture N-3 (301) is more similar to the image (202) in picture N (200) than are the images (303, 302) of pictures N-2 (300) and N-1 (201), respectively. The use of multiple reference pictures allows picture N (200) to be encoded using picture N-3 (301) as its reference picture instead of picture N-1 (201).

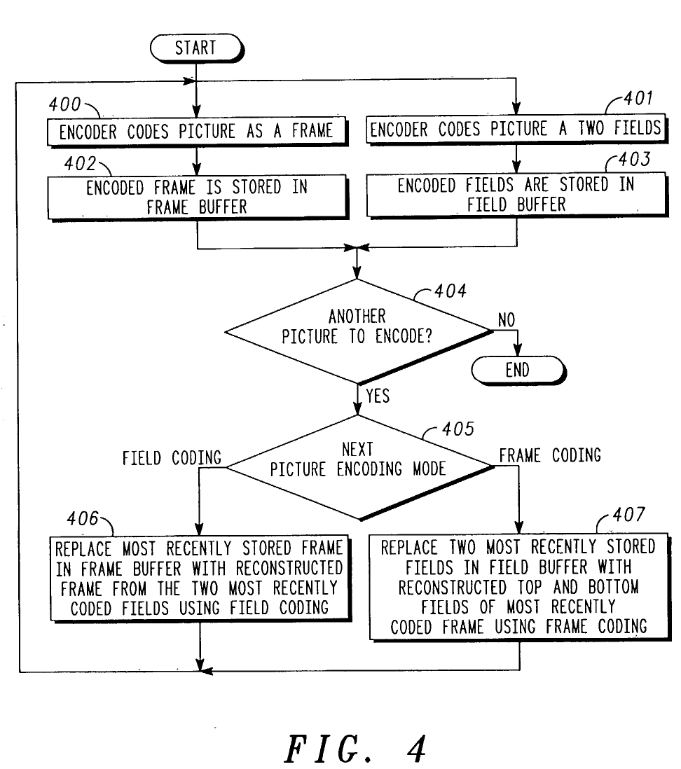

FIG. 4 is a flow chart illustrating a method of reference frame and field buffer management with multiple reference pictures in the adaptive frame/field encoding of digital video content comprising a stream of I and P pictures according to an embodiment of the present invention. The method is preferably used in conjunction with the temporal prediction with motion compensation algorithm.

The process of FIG. 4 assumes a stream of pictures that are each to be encoded. The coding is preferably adaptive frame/field coding. In adaptive frame/field coding, each picture can preferably be encoded as either a frame or as a field, regardless of the previous picture's encoding type. In adaptive frame/field coding, the encoder preferably determines which type of coding, frame or field coding, is more advantageous for each picture and chooses that type of encoding for the picture. The exact method of choosing which type of coding will be used is not critical to the present invention and will not be detailed herein.

The method of frame and field buffer management explained in connection with FIG. 4 employs and constantly updates two buffers, the frame buffer and the field buffer. Because it is preferable for a decoder that is decoding the encoded pictures to read a buffer that contains only frames or only fields, the frame and field buffers are updated after each picture is encoded in a manner such that the frames in the frame buffer correspond correctly to the fields in the field buffer. This allows the decoder to decode pictures that have been encoded using adaptive frame/field coding.

As shown in FIG. 4, the process of reference frame and field buffer management starts with the encoder coding a picture as both a frame (400) and as two fields (401). One of the two fields is a first field and the other field is a second field. The first field that is encoded is commonly referred to as a top field and the second field that is encoded is commonly referred to as a bottom field. Although the terms “first field” and “top field,” as well as the terms “second field” and “bottom field” will be used interchangeably hereafter and in the appended claims, unless otherwise specifically denoted, the first field can be the bottom field and the second field encoded can be the top field according to another embodiment of the present invention. The coding of the picture as a frame (400) and as two fields (401) can be done in parallel, as shown in FIG. 4, or sequentially. The method and order of coding the picture as a frame (400) and as two fields (401) can vary as best serves a particular application.

As shown in FIG. 4, the encoded frame is then stored in the frame buffer (402) by the encoder and the two encoded fields are stored in the field buffer (403) by the encoder. The frame and field buffers can preferably store any number of frames or fields. After the encoded frame and encoded fields have been stored in the frame buffer (402) and in the field buffer (403), respectively, the encoder determines if there is another picture to encode (404). If there is another picture to encode, the encoder determines the mode of encoding that is to be used with the next picture that is to be encoded (405).

If the encoder determines that field coding is to be used for the next picture, the encoded frame that had most recently been stored in the frame buffer is replaced in the frame buffer by a frame that is reconstructed from the two fields that had been most recently encoded using field coding (406). The method of reconstructing a frame from the two encoded fields will vary as best serves a particular application and can be easily performed by one who is skilled in the art.

Likewise, if the encoder determines that frame coding is to be used for the next picture, the two most recently encoded fields that had been stored in the field buffer are replaced in the field buffer by reconstructed first and second fields of the most recently encoded frame using frame coding (407). The method of reconstructing first and second fields from an encoded frame will vary as best serves a particular application and can be easily performed by one who is skilled in the art.

The replacement of the most recently stored frame in the frame buffer or the replacement of the two most recently stored fields in the field buffer, depending on the type of coding chosen for the next picture, ensures that the frames in the frame buffer and the fields in the field buffer always refer to the same pictures. The generation and placement of the reconstructed frames and the reconstructed first and second fields in the frame and field buffers, respectively, allows the use of adaptive frame/field coding in the encoding of digital video content.

As mentioned previously, under principles of an embodiment of the present invention, encoded B pictures can be used as reference pictures for other B pictures that are to be encoded. However, a P picture can only have an encoded I or P picture as its reference picture. According to another embodiment of the present invention, there are two equally viable methods of storing encoded B pictures in frame and field buffers. First, the encoded B pictures can be saved in the same frame and field buffers that are used to store the encoded I and P pictures. Second, the encoded B pictures can be saved in separate frame and field buffers that are dedicated solely to the storage of encoded B pictures.

The detailed procedures for frame and field buffer management with multiple reference pictures in the encoding of digital video content will now be explained. The procedures depend on whether B pictures are included in the sequence of pictures that are to be encoded. Thus, six different procedures will be explained: frame buffer management without B pictures, frame buffer management with B pictures not using a separate frame buffer for the B pictures, frame buffer management with B pictures using a separate frame buffer for the B pictures, field buffer management without B pictures, field buffer management with B pictures not using a separate field buffer for the B pictures, and field buffer management with B pictures using a separate field buffer for the B pictures.

In the following explanations, a number of variables will be used to describe embodiments of the present invention. The variable mref[n], where n=0,1, . . . ,N-1, refers to the position in the frame buffer containing an nth reference frame or to the position in the field buffer containing an nth reference field. The frame and field buffers contain N reference frames and N reference fields, respectively. The reference frames and fields can be in the forward or backward temporal direction in relation to the particular picture that is being encoded. Another variable, mref_P, refers to the position containing an additional reference frame in the frame buffer. The variable mref_P is utilized when there are B pictures in the sequence of pictures that are to be encoded as frames. The variables mref_P_top and mref_P_bot refer to positions in the field buffer containing an additional reference top field and an additional reference bottom field, respectively. The variables mref_P_top and mref_P_bot are utilized when there are B pictures that are to be encoded as two fields. The same variables will be used to describe the separate frame and field buffers that can be used to store only B pictures. The frame buffer that is used to store only B pictures encoded as frames will be referred to as the “B frame buffer” and the field buffer that is used to store only B pictures encoded as fields will be referred to as the “B field buffer.” As referred to hereafter and in the appended claims, unless otherwise denoted, the “frame buffer” is the frame buffer in which encoded I, P, and B reference frames are stored and the “field buffer” is the field buffer in which encoded I, P, and B reference fields are stored. Similarly, as referred to hereafter and in the appended claims, unless otherwise denoted, the term “B frame buffer” refers to the frame buffer in which only encoded B reference frames are stored and the term “B field buffer” refers to the field buffer in which only encoded B reference fields are stored.

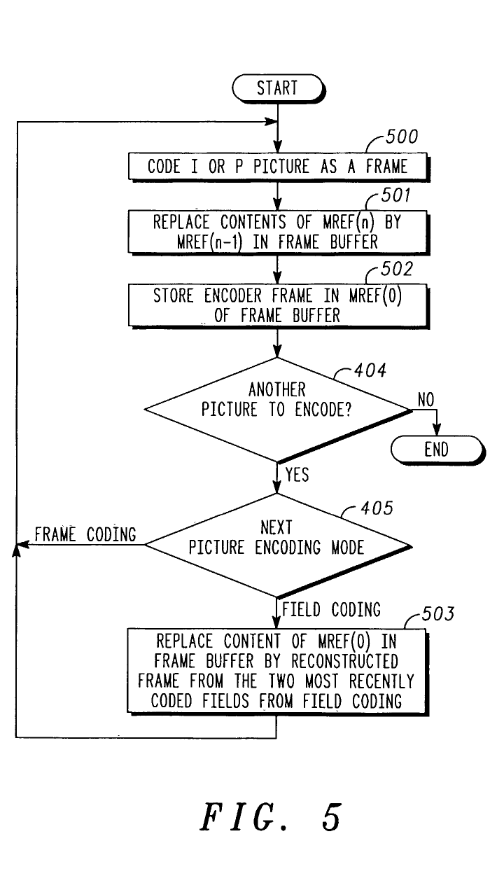

FIG. 5 illustrates a detailed procedure for frame buffer management without B pictures according to an embodiment of the present invention. As shown in FIG. 5, the procedure starts with the encoder coding an I or P picture as a frame (500). After coding the I or P frame, the contents of mref[n] in the frame buffer are replaced by the contents of mref[n-1] (501) for n=0,1, . . . ,N-1 and the encoded I or P frame is stored in mref[0] (502).

After the encoded I or P frame is stored in mre[0] and if the encoder determines that another picture is to be coded (404), the encoder determines the mode of encoding that will be used with the next picture that is to be encoded (405). If frame coding is selected for the next picture, no further action is necessary and the encoder encodes the next picture as a frame, repeating the process described in connection with FIG. 5. However, if field coding is selected for the next picture, the content of mref[0] is replaced by the frame that is reconstructed from the two most recently coded fields using field coding (503).

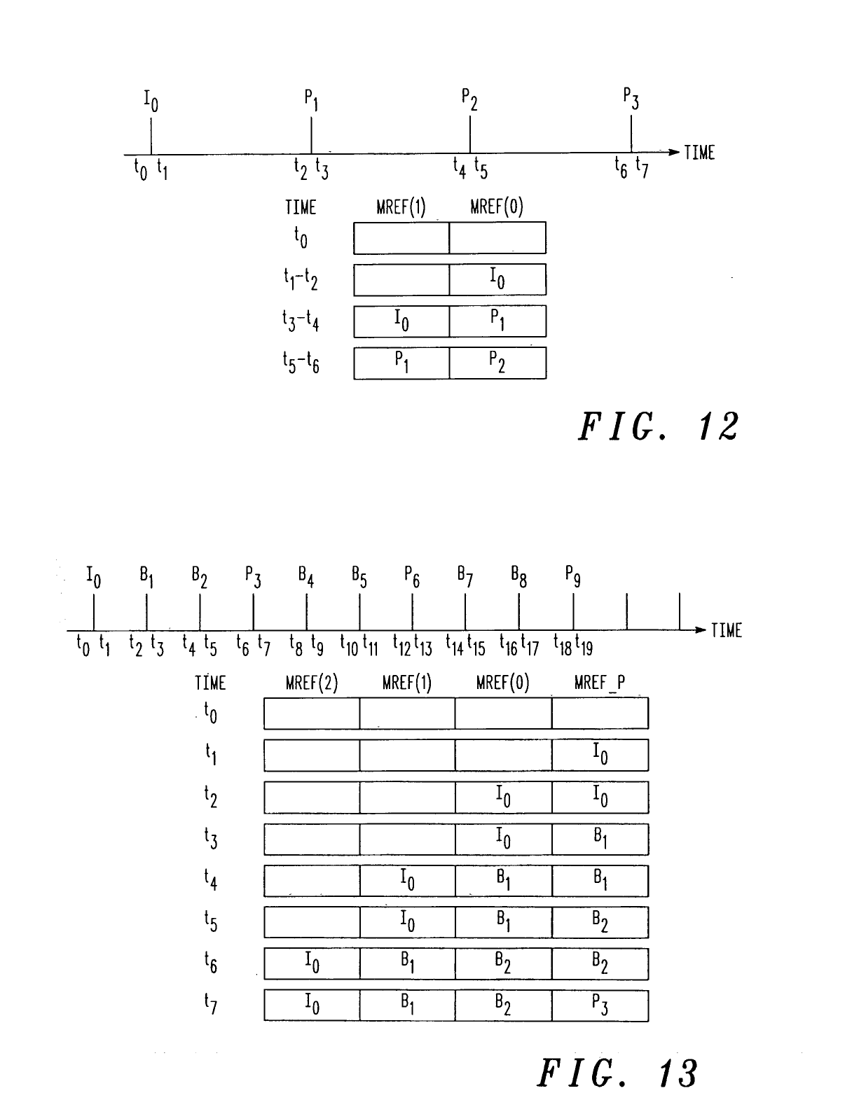

FIG. 12 shows an example of frame buffer management without B pictures as described in connection with FIG. 5. However, in the example of FIG. 12, it is assumed that each picture is coded in frame mode and that the field coding mode is never selected by the encoder. As shown in FIG. 12, the exemplary frame buffer consists of two possible reference frame locations, mref[0] and mref[1]. The exemplary frame buffer consists of two possible reference frame locations for illustrative purposes only and, according to an embodiment of the present invention, is not limited to any specific number of reference frame locations.

As shown in FIG. 12, a number I and P pictures are to be encoded as frames. The frame buffer is empty at time t₀. Between the times t₀ and t₁, the first picture, I₀, is encoded as a frame. After it is encoded, I₀ is stored in mref[0]. I₀ remains in mref[0] during the time interval t₁-t₂ and is the reference frame for the encoding of P₁, which is encoded between times t₂ and t₃. After P₁ is encoded, I₀ is stored in mref[1] and P₁ is stored in mref[0]. I₀ and P₁ remain in mref[1] and mref[0], respectively, during the time interval t₃-t₄ and are the reference frames for the encoding of P₂. P₂ is encoded between times t₄ and t₅. After P₂ is encoded, P₁ is stored in mref[1] and P₂ is stored in mref[0]. P₁ and P₂ remain in mref[1] and mref[0], respectively, during the time interval t₅-t₆ and are the reference frames for the encoding of P₃. The procedure continues until all the pictures are encoded.

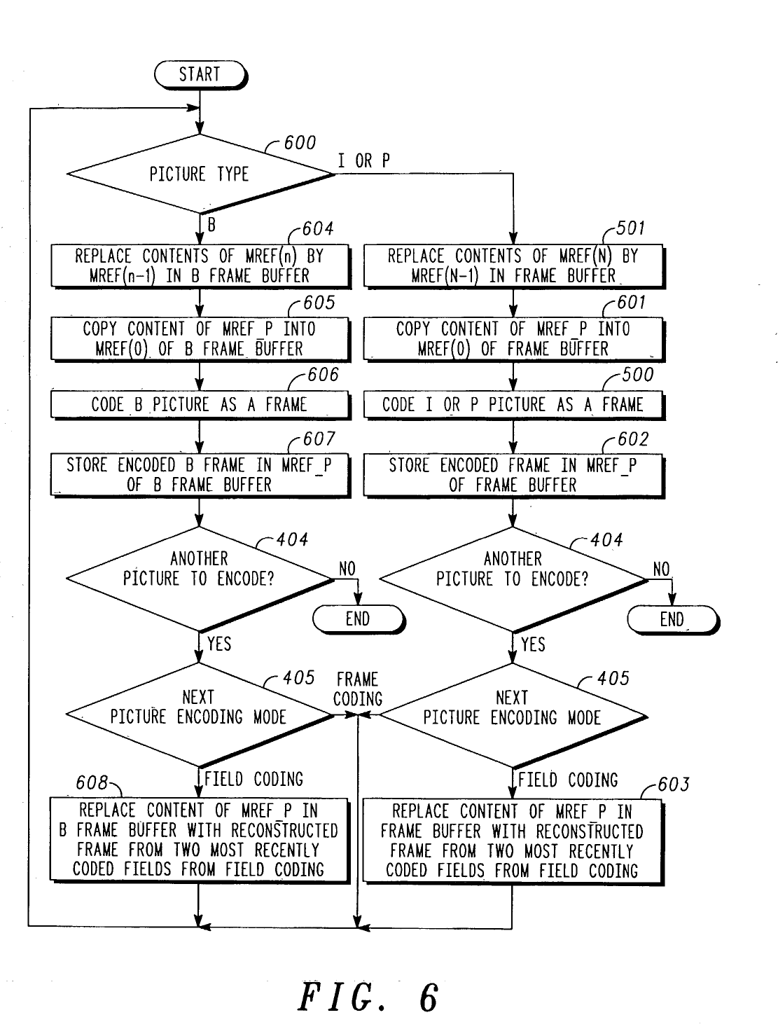

FIG. 6 illustrates a detailed procedure for frame buffer management with B pictures that are to be encoded as frames and stored in a B frame buffer according to an embodiment of the present invention. As shown in FIG. 6, the procedure starts with the encoder determining which picture type is to be encoded (600). If the picture to be encoded is an I or P picture, the contents of mref[n] in the frame buffer are first replaced by the contents of mref[n-1] (501) for n=0,1, . . . ,N-1. The content of mref_P is then copied into mref[0] of the frame buffer (601). The encoder then codes the I or P picture as a frame (500). After coding the I or P frame, the encoded frame is stored in mref_P (602).

After the encoded frame has been stored in mref_P (602) and if the encoder determines that another picture is to be coded (404), the encoder determines the mode of encoding that will be used with the next picture that is to be encoded (405). If frame coding is selected for the next picture, no further action is necessary and the encoder encodes the next picture as a frame, repeating the process described in connection with FIG. 6. However, if field coding is selected for the next picture, the content of mref_P is replaced by the reconstructed frame from the two most recently coded fields using field coding (603).

However, if a B picture is to be encoded, the contents of mref[n] in the B frame buffer are first replaced by the contents of mref[n-1] (604) for n=0,1, . . . ,N-1. The content of mref_P is then copied into mref[0] of the B frame buffer (605). The encoder then codes the B picture as a frame (606). After the B picture is encoded as a frame, it is stored in mref_P of the B frame buffer (607).

After the encoded frame has been stored in mref_P of the B frame buffer (607) and if the encoder determines that another picture is to be coded (404), the encoder determines the mode of encoding that will be used with the next picture that is to be encoded (405). If frame coding is selected for the next picture, no further action is necessary and the encoder encodes the next picture as a frame, repeating the process described in connection with FIG. 6. However, if field coding is selected for the next picture, the content of mref_P of the B frame buffer is replaced by the reconstructed frame from the two most recently coded fields using field coding (608).

FIG. 10 illustrates a detailed procedure for frame buffer management with B pictures and where the B pictures that are encoded as frames are stored in the same frame buffer as the I and P pictures that are encoded as frames according to an embodiment of the present invention. The frame buffer management procedure is almost identical to the frame buffer management procedure of FIG. 6. As shown in FIG. 10, the procedure starts with the contents of mref[n] in the frame buffer being replaced by the contents of mref[n-1] (501) for n=0,1, . . . ,N-1. The content of mref_P is then copied into mref[0] of the frame buffer (601). The encoder then codes the I, P, or B picture as a frame (900). After coding the I, P, or B frame, the encoded frame is stored in mref_P (602).

After the encoded frame has been stored in mref_P (602) and if the encoder determines that another picture is to be coded (404), the encoder determines the mode of encoding that will be used with the next picture that is to be encoded (405). If frame coding is selected for the next picture, no further action is necessary and the encoder encodes the next picture as a frame, repeating the process described in connection with FIG. 10. However, if field coding is selected for the next picture, the content of mref_P is replaced by the reconstructed frame from the two most recently coded fields using field coding (603).

Because a P picture that is to be encoded as a frame can only have encoded I or P frames as its reference frames, the encoder ignores the encoded B frames in the frame buffer according to an embodiment of the present invention.

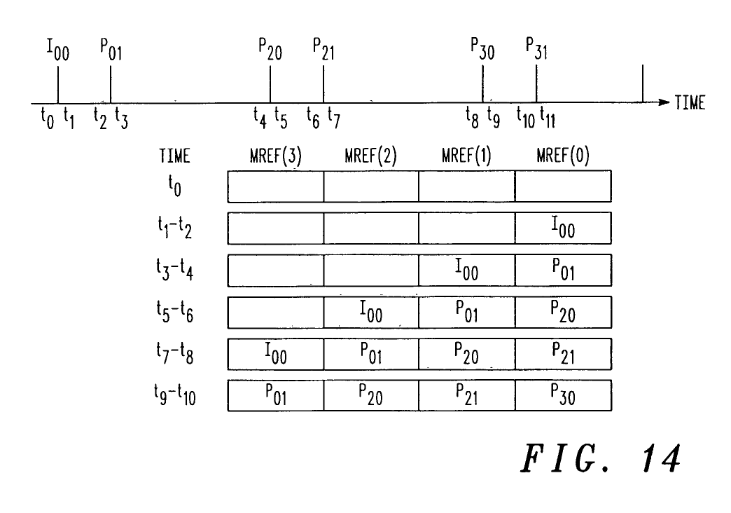

FIG. 13 shows an example of frame buffer management including B pictures where the encoded B pictures are stored in the same frame buffer as are the encoded I and P pictures, as described in connection with FIG. 10. However, in the example of FIG. 13, it is assumed that each picture is coded in frame mode and that the field coding mode is never selected by the encoder. As shown in FIG. 13, the exemplary frame buffer consists of four possible reference frame locations, mref[0], mref[1], mref[2], and mref_P. The exemplary frame buffer consists of four possible reference frame locations for illustrative purposes only and, according to an embodiment of the present invention, is not limited to any specific number of reference frame locations.

As shown in FIG. 13, a number of I, P, and B pictures are to be encoded as frames. The frame buffer is empty at time t₀. Between the times t₀ and t₁, the first picture, I₀, is encoded as a frame. After it is encoded, I₀ is stored in mref_P. At time t₂, or before the encoding of B₁, I₀ is copied from mref_P into mref[0]. I₀ is then the reference frame for B₁, which is encoded between times t₂ and t₃. After B₁ has been encoded, it is stored in mref_P. I₀ and B₁ are the reference frames for the encoding of B₂. The procedure continues until all the pictures are encoded. FIG. 13 shows the frame buffer contents at various times during the encoding process.

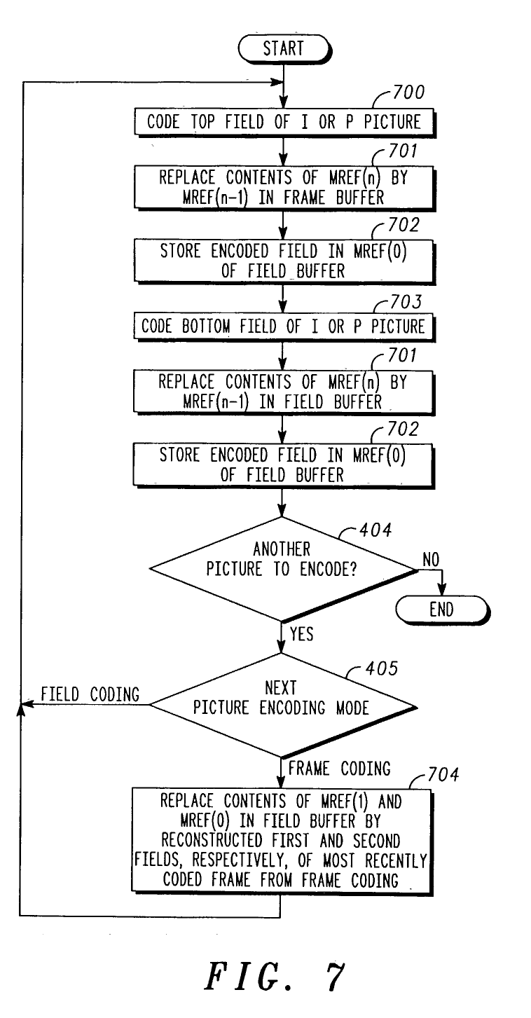

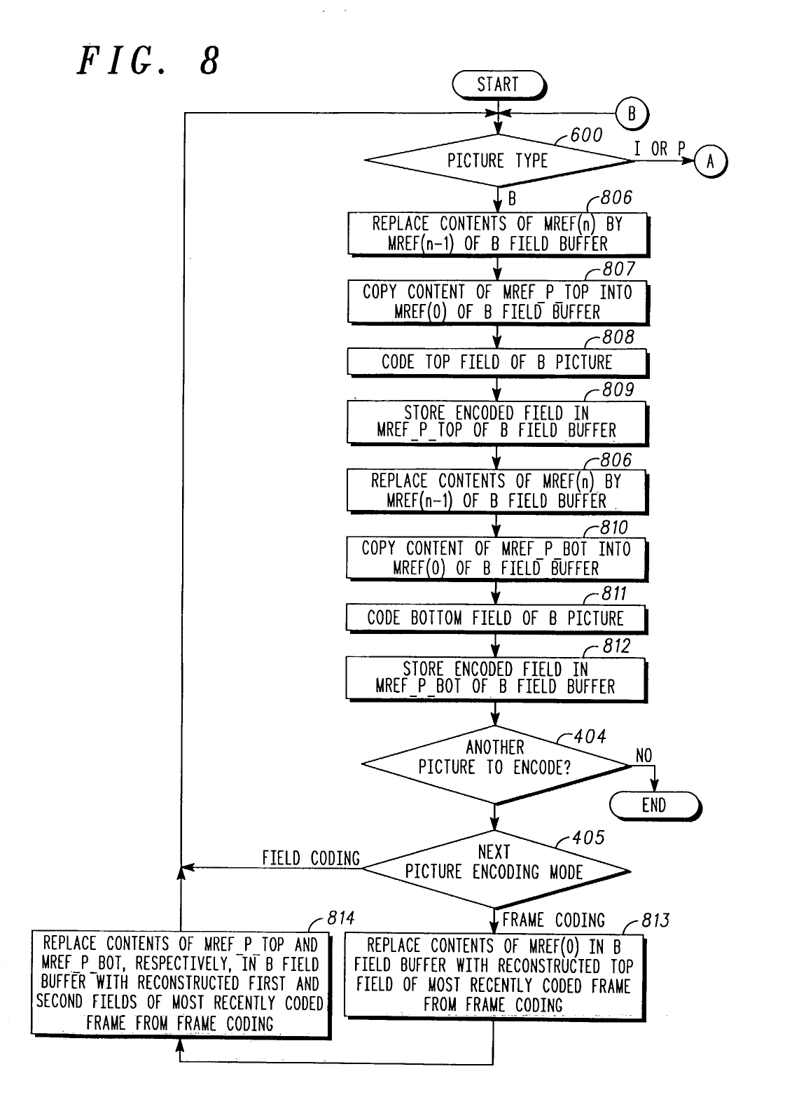

FIG. 7 illustrates a detailed procedure for field buffer management without B pictures according to an embodiment of the present invention. The procedure codes the I or P picture as a top and bottom field. As shown in FIG. 7, the procedure starts with the encoder coding the top field of the I or P picture (700). After coding the I or P top field, the contents of mref[n] in the field buffer are replaced by the contents of mref[n-1] (701) for n=0,1, . . . ,N-1 and the encoded I or P top field is stored in mref[0] (702).

After the encoded I or P top field is stored in mref[0], the encoder codes the bottom field of the I or P picture (703). After coding the I or P top field, the contents of mref[n] in the field buffer are replaced by the contents of mref[n-1] (701) for n=0,1, . . . ,N-1 and the encoded I or P bottom field is stored in mref[0] (702).

After the encoded I or P bottom field is stored in mref[0] and if the encoder determines that another picture is to be coded (404), the encoder determines the mode of encoding that will be used with the next picture that is to be encoded (405). If field coding is selected for the next picture, no further action is necessary and the encoder encodes the next picture as a top and bottom field, repeating the process described in connection with FIG. 7. However, if frame coding is selected for the next picture, the contents of mref[1] and mref[0] are replaced by the reconstructed first and bottom fields, respectively, of the most recently encoded frame using frame coding (704).

Although the detailed procedure of field buffer management without B pictures as described in FIG. 7 dictates that the top field is encoded before the bottom field, another embodiment of the present invention provides a procedure wherein the bottom field is encoded before the top field. In this case, the step (703) of FIG. 7 differs in that the contents of mref[1] and mref[0] are replaced by the reconstructed second and top fields, respectively, of the most recently encoded frame using frame coding.

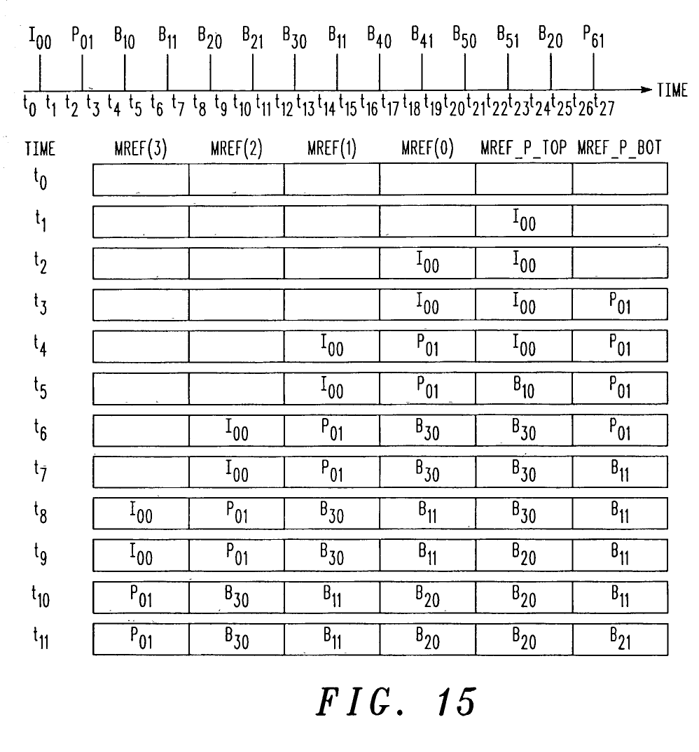

FIG. 14 shows an example of field buffer management without B pictures as described in connection with FIG. 7. However, in the example of FIG. 14, it is assumed that each picture is coded in field mode and that the frame coding mode is never selected by the encoder. As shown in FIG. 14, the exemplary field buffer consists of four possible reference field locations, mref[0], mref[1], mref[2], and mref[3]. The exemplary field buffer consists of four possible reference field locations for illustrative purposes only and, according to an embodiment of the present invention, is not limited to any specific number of reference field locations.

As shown in FIG. 14, a number I and P pictures are to be encoded as fields. The pictures are shown having two parts. The two parts refer to the top and bottom fields as which the pictures will be encoded. For example, P₂₀ corresponds to the top field of a particular picture that is to be encoded and P₂₁ corresponds to the bottom field of the same picture. As shown in FIG. 14, the field buffer is empty at time t₀. Between the times t₀ and t₁, the first field, I₀₀, is encoded. After I₀₀ is encoded, it is stored in mref[0]. I₀₀ remains in mref[0] during the time interval t₁-t₂ and is the reference field for the encoding of P₀₁, which is encoded between times t₂ and t₃. After P₀₁ is encoded, I₀₀ is stored in mref[1] and P₀₁ is stored in mref[0]. I₀₀ and P₀₁ remain in mref[1] and mref[0], respectively, during the time interval t₃-t₄ and are the reference fields for the encoding of P₂₀. P₂₀ is encoded between times t₄ and t₅. After P₂₀ is encoded, I₀₀ is stored in mref[2], P₀₁ is stored in mref[1], and P₂₀ is stored in mref[0]. I₀₀, P₀₁, and P₂₀ remain in mref[2], mref[1], and mref[0], respectively, during the time interval t₅-t₆ and are the reference frames for the encoding of P₂₁. The procedure continues until all the pictures are encoded. FIG. 14 shows the field buffer contents at various times during the encoding process.

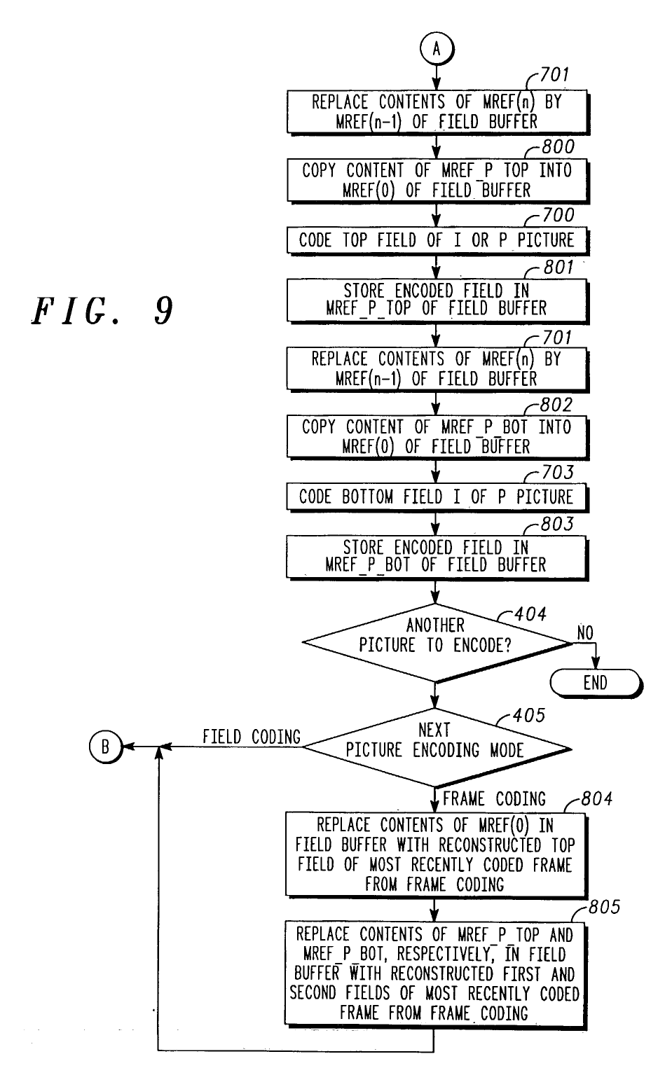

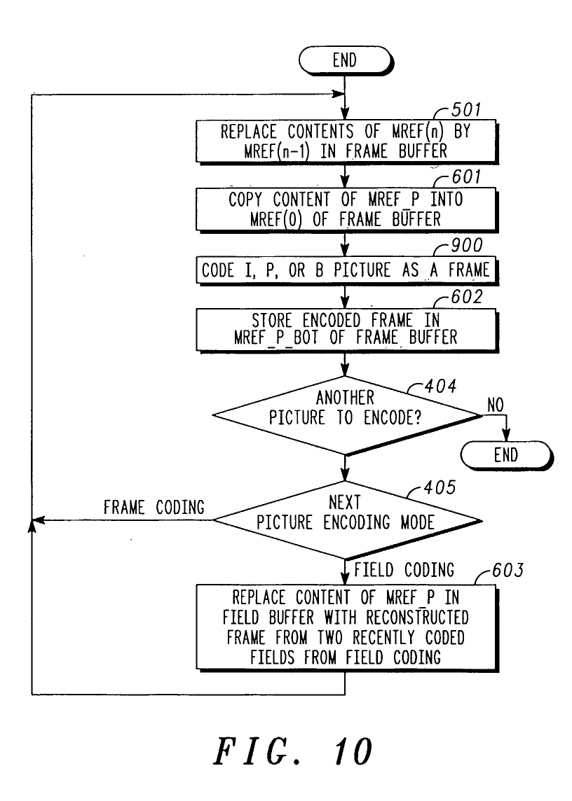

FIG. 8 and FIG. 9 illustrate a detailed procedure for field buffer management with B pictures that are to be encoded as fields and stored in a B field buffer according to an embodiment of the present invention. As shown in FIG. 8 and FIG. 9, the procedure starts with the encoder determining which picture type is to be encoded (600). If the picture to be encoded is an I or P picture, the contents of mref[n] in the field buffer are replaced by the contents of mref[n-1] (701) for n=0,1, . . . ,N-1 and the content of mref_P_top is copied into mref[0] (800) of the field buffer. The encoder then codes the top field of the I or P picture (700). The encoded I or P top field is then stored in mref_P_top (801) of the field buffer.

After the encoded I or P top field is stored in mref_P_top, the contents of mref[n] in the field buffer are replaced by the contents of mref[n-1] (701) for n=0,1, . . . ,N-1 and the content of mref_P_bot is copied into mref[0] (802). The encoder then codes the bottom field of the I or P picture (703). The encoded I or P field is then stored in mref_P_bot (803) of the field buffer.

After the encoded I or P bottom field is stored in mref_P_bot and if the encoder determines that another picture is to be coded (404), the encoder determines the mode of encoding that will be used with the next picture that is to be encoded (405). If field coding is selected for the next picture, no further action is necessary and the encoder encodes the next picture as a top and bottom field, repeating the process described in connection with FIG. 8 and FIG. 9. However, if frame coding is selected for the next picture, the content of mref[0] of the field buffer is replaced by the reconstructed first field of the most recently coded frame from frame coding (804). The contents of mref_P_top and mref_P_bot in the field buffer are replaced by the reconstructed first and second fields, respectively, of the most recently coded frame from frame coding (805).

However, if a B picture is to be encoded as a field, the contents of mref[n] in the B field buffer are replaced by the contents of mref[n-1] (701) for n=0,1, . . . ,N-1 and the content of mref_P_top is copied into mref[0] (800). The encoder then codes the top field of the I or P picture (700). The encoded I or P top field is then stored in mref_P_top (801).

After the encoded I or P top field is stored in mref_P_top, the contents of mref[n] in the B field buffer are replaced by the contents of mref[n-1] (806) for n=0,1, . . . ,N-1 and the content of mref_P_bot is copied into mref[0] (807). The encoder then codes the bottom field of the B picture (808). The encoded B field is then stored in mref_P_bot (809) of the B field buffer.

After the encoded B bottom field is stored in mref_P_bot and if the encoder determines that another picture is to be coded (404), the encoder determines the mode of encoding that will be used with the next picture that is to be encoded (405). If field coding is selected for the next picture, no further action is necessary and the encoder encodes the next picture as a top and bottom field, repeating the process described in connection with FIG. 8 and FIG. 9. However, if frame coding is selected for the next picture, the content of mref[0] of the B field buffer is replaced by the reconstructed first field of the most recently coded frame from frame coding (813). The contents of mref_P_top and mref_P_bot in the B field buffer are replaced by the reconstructed first and second fields, respectively, of the most recently coded frame from frame coding (814).

Although the detailed procedure of field buffer management with B pictures as described in FIG. 8 and FIG. 9 dictates that the top field is encoded before the bottom field, another embodiment of the present invention provides a procedure wherein the bottom field is encoded before the top field.

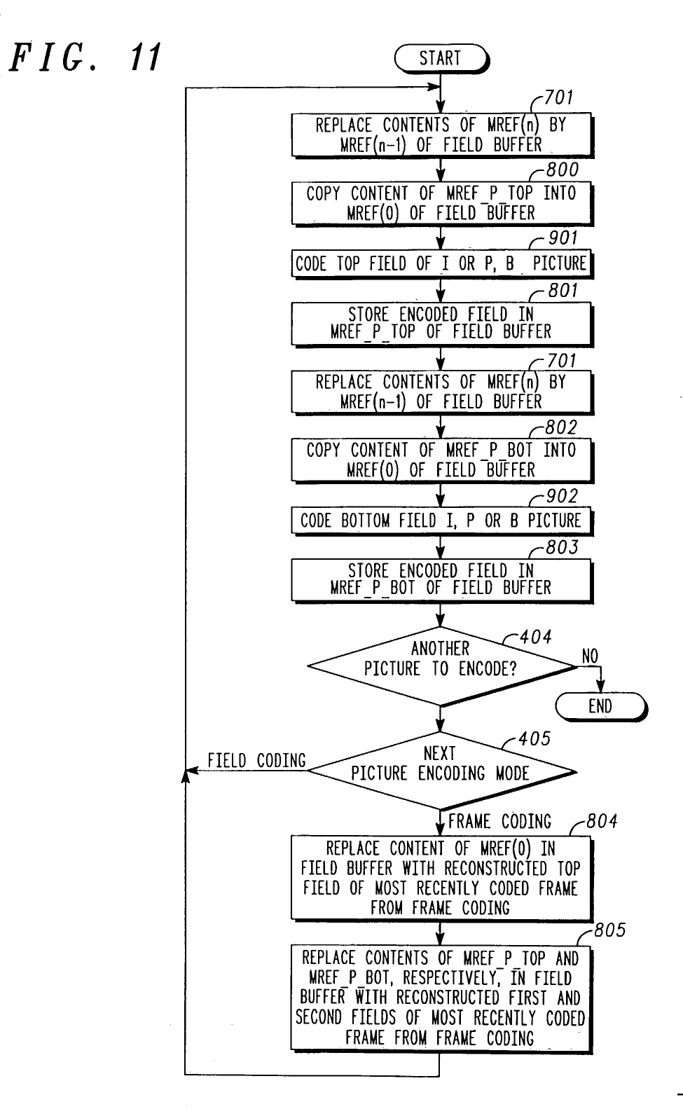

FIG. 11 illustrates a detailed procedure for field buffer management with B pictures and where the B pictures that are encoded as fields are stored in the same field buffer as the I and P pictures that are encoded as fields according to an embodiment of the present invention. The field buffer management procedure is almost identical to the field buffer management procedure of FIG. 8 and FIG. 9. As shown in FIG. 11, the procedure starts with the contents of mref[n] in the field buffer being replaced by the contents of mref[n-1] (701) for n=0,1, . . . ,N-1 and the content of mref_P_top is copied into mref[0] (800) of the field buffer. The encoder then codes the top field of the I or P picture (700). The encoded I, P, or B top field is then stored in mref_P_top (901) of the field buffer.

After the encoded I, P, or B top field is stored in mref_P_top, the contents of mref[n] in the field buffer are replaced by the contents of mref[n-1] (701) for n=0,1, . . . ,N-1 and the content of mref_P_bot is copied into mref[0] (802). The encoder then codes the bottom field of the I, P, or B picture (902). The encoded I, P, or B field is then stored in mref_P_bot (803) of the field buffer.

After the encoded I or P bottom field is stored in mref_P_bot and if the encoder determines that another picture is to be coded (404), the encoder determines the mode of encoding that will be used with the next picture that is to be encoded (405). If field coding is selected for the next picture, no further action is necessary and the encoder encodes the next picture as a top and bottom field, repeating the process described in connection with FIG. 11. However, if frame coding is selected for the next picture, the content of mref[0] of the field buffer is replaced by the reconstructed first field of the most recently coded frame from frame coding (804). The contents of mref_P_top and mref_P_bot in the field buffer are replaced by the reconstructed first and second fields, respectively, of the most recently coded frame from frame coding (805).

FIG. 15 shows an example of field buffer management with B pictures as described in connection with FIG. 11. However, in the example of FIG. 15, it is assumed that each picture is coded in field mode and that the frame coding mode is never selected by the encoder. As shown in FIG. 15, the exemplary field buffer consists of six possible reference field locations, mref[0], mref[1], mref[2], mref[3], mref_P_top, and mref_P_bot. The exemplary field buffer consists of six possible reference field locations for illustrative purposes only and, according to an embodiment of the present invention, is not limited to any specific number of reference field locations.

As shown in FIG. 15, a number I and P pictures are to be encoded as fields. The pictures are shown having two parts. The two parts refer to the top and bottom fields that the pictures will be encoded as. For example, P₂₀ corresponds to the top field of a particular picture that is to be encoded as two fields and P₂₁ corresponds to the bottom field of the same picture. The field buffer is empty at time t₀. Between the times t₀ and t₁, the first field, I₀₀, is encoded. After I₀₀ is encoded, it is stored in mref_P_top. At time t₂, or before P₀₁ is encoded, I₀₀ is copied from mref_P_top to mref[0]. I₀₀ is the reference field for the encoding of P₀₁, which is encoded between times t₂ and t₃. After P₀₁ is encoded, P₀₁ is stored in mref_P_bot. At time t₄, or before B₁₀ is encoded, I₀₀ is stored in mref[1] and P₀₁ is coped from mref_P_bot into mref[0]. Between times t₄ and t₅, B₁₀ is encoded as a top field and is stored in mref_P_top. At time t₆, or before B₁₁ is encoded, the contents of mref[n] are replaced by mref[n-1] and the content of mref_P_top is copied into mref[0]. B₁₁ is encoded between the times t₆ and t₇ and is stored in mref_P_bot. The procedure continues until all the pictures are encoded. FIG. 15 shows the field buffer contents at various times during the encoding process.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best illustrate the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A method of adaptive frame/field encoding of digital video content using temporal prediction with motion compensation with multiple reference pictures, said digital video content comprising a stream of pictures which can each be intra or predicted pictures, some of said pictures being encoded as frames and some of said pictures being encoded as first and second fields, said method comprising, for each successive picture in said stream:
storing each successive picture that is encoded as a frame in a frame buffer, each picture that is stored becoming one of a number of reference pictures for other pictures in said stream that are to be encoded as a frame;
storing each successive picture that is encoded as a first field and a second field in a field buffer, each picture that is stored becoming one of a number of reference pictures for other pictures in said stream that are to be encoded as a first field and a second field; and
managing and updating contents of said frame buffer and said field buffer in accordance with a mode of encoding that is selected before each picture in said stream of pictures is encoded, said mode being either a frame coding mode or a field coding mode.

2. The method of claim 1, further comprising:
encoding each successive picture as a frame and as said first and said second field resulting in an encoded frame and an encoded first field and an encoded second field;
replacing contents of a reference position n (mref[n]) of said frame buffer with contents of a reference position n-1 (mref[n-1]) of said frame buffer, said contents comprising reference frames;
storing said encoded frame in a reference position 0 (mref[0]) of said frame buffer;
replacing contents of mref[n] of said field buffer with contents of mref[n-1] of said field buffer after said encoding of said first field and before said encoding of said second field, said contents comprising reference fields;
storing said encoded first field in mref[0] of said field buffer;
replacing said contents of mref[n] of said field buffer with said contents of mref[n-1] of said field buffer after said encoding of said second field;
storing said encoded second field in mref[0] of said field buffer;
determining a next picture encoding mode if another picture in said stream of pictures is to be encoded, said next picture encoding mode being either said frame coding mode or said field coding mode;
replacing said encoded frame in mref[0] of said frame buffer with a reconstructed frame that is reconstructed from said encoded first field and said encoded second field if said next picture encoding mode is said field coding mode; and
replacing said encoded first field in a reference position 1 (mref[1]) of said field buffer with a reconstructed first field and replacing said encoded second field of mref[0] of said field buffer with a reconstructed second field, said reconstructed first and second fields being reconstructed from said encoded frame if said next picture encoding mode is said frame coding mode.

3. The method of claim 2, wherein said first field comprises a top field and said second field comprises a bottom field.

4. The method of claim 2, wherein said first field comprises a bottom field and said second field comprises a top field.

5. A method of adaptive frame/field encoding of digital video content using temporal prediction with motion compensation with multiple reference pictures, said digital video content comprising a stream of pictures which can each be intra, predicted, or bidirectionally interpolated pictures, said method comprising, for each successive intra, predicted, or bidirectionally interpolated picture in said stream:
storing each successive intra, predicted, or bidirectionally interpolated picture that is encoded as a frame in a frame buffer, each intra, predicted, or bidirectionally interpolated picture that is stored becoming one of a number of reference pictures for other pictures in said stream that are to be encoded as a frame;
storing each successive intra, predicted, or bidirectionally interpolated picture that is encoded as a first field and a second field in a field buffer, each intra, predicted, or bidirectionally interpolated picture that is stored becoming one of a number of reference pictures for other pictures in said stream that are to be encoded as a first field and a second field; and
managing and updating contents of said frame buffer and said field buffer in accordance with a mode of encoding that is selected before each picture in said stream of pictures is encoded, said mode being either a frame coding mode or a field coding mode;
wherein said bidirectionally interpolated pictures that are stored in said frame and field buffers are reference frames and reference fields for only other bidirectionally interpolated pictures that are to be encoded.

6. The method of claim 5, further comprising:
replacing contents of a reference position n (mref[n]) of said frame buffer with contents of a reference position n-1 (mref[n-1]) of said frame buffer;
copying content of an additional reference frame position (mref_P) of said frame buffer into a reference position 0 (mref[0]) of said frame buffer;
replacing contents of mref[n] of said field buffer with contents of mref[n-1] of said field buffer;
copying content of an additional reference top field position (mref_P_top) of said field buffer into mref[0] of said field buffer;
encoding each successive intra, predicted, or bidirectionally interpolated picture as a frame and as a first and a second field resulting in an encoded frame and an encoded first field and an encoded second field;
storing said encoded frame in mref_P of said frame buffer;
storing said encoded first field in mref_P_top of said field buffer;
replacing said contents of mref[n] of said field buffer with said contents of mref[n-1] of said field buffer after said encoding of said first field and before said encoding of said second field;
copying content of an additional reference bottom field position (mref_P_bot) of said field buffer into mref[0] of said field buffer;
storing said encoded second field in mref_P_bot of said field buffer;
determining a next picture encoding mode if another picture in said stream of pictures is to be encoded, said next picture encoding mode being either a frame coding mode or a field coding mode;
replacing said content of mref_P of said frame buffer with a reconstructed frame that is reconstructed from said encoded first field and said encoded second field if said next picture encoding mode is said field coding mode;
replacing content of mref[0] of said field buffer with a reconstructed first field, said reconstructed first field being reconstructed from said encoded frame if said next picture encoding mode is said frame coding mode; and
replacing said contents of mref_P_top and mref_P bot, respectively, with said reconstructed first field and a reconstructed second field, said reconstructed second field being reconstructed from said encoded frame if said next picture encoding mode is said frame coding mode.

7. The method of claim 6, wherein said first field comprises a top field and said second field comprises a bottom field.

8. The method of claim 6, wherein said first field comprises a bottom field and said second field comprises a top field.

9. A method of adaptive frame/field encoding of digital video content using temporal prediction with motion compensation with multiple reference pictures, said digital video content comprising a stream of pictures which can each be intra, predicted, or bidirectionally interpolated pictures, said method comprising, for each successive intra, predicted, or bidirectionally interpolated picture in said stream:
storing each successive intra or predicted picture that is encoded as a frame in a frame buffer and each successive bidirectionally interpolated picture that is encoded in a B frame buffer, each picture that is stored becoming one of a number of reference pictures for other pictures in said stream that are to be encoded as a frame;
storing each successive intra or predicted picture that is encoded as a first field and a second field in a field buffer and each successive bidirectionally interpolated picture that is encoded as a first field and a second field in a B field buffer, each picture that is stored becoming one of a number of reference pictures for other pictures in said stream that are to be encoded as a first field and a second field; and
managing and updating contents of said frame buffer, said B frame buffer, said field buffer, and said B field buffer in accordance with a mode of encoding that is selected before each picture in said stream of pictures is encoded, said mode being either a frame coding mode or a field coding mode;
wherein said bidirectionally interpolated pictures that are stored in said B frame and field buffers are reference frames and reference fields for only other bidirectionally interpolated pictures that are to be encoded.

10. The method of claim 9, further comprising:
replacing contents of a reference position n (mref[n]) of said frame buffer with contents of a reference position n-1 (mref[n-1]) of said frame buffer;
copying content of an additional reference frame position (mref_P) of said frame buffer into a reference position 0 (mref[0]) of said frame buffer;
replacing contents of mref[n] of said field buffer with contents of mref[n-1] of said field buffer;
copying content of an additional reference top field position (mref_P_top) of said field buffer into mref[0] of said field buffer;
encoding each successive intra or predicted picture as a frame and as a first and a second field resulting in an encoded frame and an encoded first field and an encoded second field;
storing said encoded frame in mref_P of said frame buffer;
storing said encoded first field in mref_P_top of said field buffer;
replacing said contents of mref[n] of said field buffer with said contents of mref[n-1] of said field buffer after said encoding of said first field and before said encoding of said second field;
copying content of an additional reference bottom field position (mref_P_bot) of said field buffer into mref[0] of said field buffer;
storing said encoded second field in mref_P_bot of said field buffer;
determining a next picture encoding mode if another picture in said stream of pictures is to be encoded, said next picture encoding mode being either a frame coding mode or a field coding mode;
replacing said content of mref_P of said frame buffer with a reconstructed frame that is reconstructed from said encoded first field and said encoded second field if said next picture encoding mode is said field coding mode;
replacing content of mref[0] of said field buffer with a reconstructed first field, said reconstructed first field being reconstructed from said encoded frame if said next picture encoding mode is said frame coding mode; and
replacing said contents of mref_P_top and mref_P_bot, respectively, with said reconstructed first field and a reconstructed second field, said reconstructed second field being reconstructed from said encoded frame if said next picture encoding mode is said frame coding mode.

11. The method of claim 9, further comprising:
replacing contents of a reference position n (mref[n]) of said B frame buffer with contents of a reference position n-1 (mref[n-1]) of said B frame buffer;
copying content of an additional reference frame position (mref_P) of said B frame buffer into a reference position 0 (mref[0]) of said B frame buffer;
replacing contents of mref[n] of said B field buffer with contents of mref[n-1] of said field buffer;
copying content of an additional reference top field position (mref_P_top) of said B field buffer into mref[0] of said B field buffer;
encoding each successive bidirectionally interpolated picture as a frame and as a first and a second field resulting in an encoded frame and an encoded first field and an encoded second field;
storing said encoded frame in mref_P of said B frame buffer;
storing said encoded first field in mref_P_top of said B field buffer;
replacing said contents of mref[n] of said B field buffer with said contents of mref[n-1] of said B field buffer after said encoding of said first field and before said encoding of said second field;
copying content of an additional reference bottom field position (mref_P_bot) of said B field buffer into mref[0] of said B field buffer;
storing said encoded second field in mref_P_bot of said B field buffer;
determining a next picture encoding mode if another picture in said stream of pictures is to be encoded, said next picture encoding mode being either a frame coding mode or a field coding mode;
replacing said content of mref_P of said B frame buffer with a reconstructed frame that is reconstructed from said encoded first field and said encoded second field if said next picture encoding mode is said field coding mode;
replacing content of mref[0] of said B field buffer with a reconstructed first field, said reconstructed first field being reconstructed from said encoded frame if said next picture encoding mode is said frame coding mode; and
replacing said contents of mref_P_top and mref_P_bot, respectively, with said reconstructed first field and a reconstructed second field, said reconstructed second field being reconstructed from said encoded frame if said next picture encoding mode is said frame coding mode.

12. The method of claim 10, wherein said first field comprises a top field and said second field comprises a bottom field.

13. The method of claim 10, wherein said first field comprises a bottom field and said second field comprises a top field.

14. The method of claim 11, wherein said first field comprises a top field and said second field comprises a bottom field.

15. The method of claim 11, wherein said first field comprises a bottom field and said second field comprises a top field.

16. An encoder for adaptive frame/field encoding of digital video content using temporal prediction with motion compensation with multiple reference pictures, said digital video content comprising a stream of pictures which can each be intra or predicted pictures, said encoder comprising:
a frame buffer for storing pictures that are encoded as frames, said pictures being used as reference pictures for other pictures in said stream that are to be encoded as frames; and
a field buffer for storing pictures that are encoded as a first field and a second field, said pictures being used as reference pictures for other pictures in said stream that are to be encoded as a first field and a second field;
wherein said encoder manages and updates contents of said frame buffer and said field buffer in accordance with a mode of encoding that is selected before each picture in said stream of pictures is encoded by said encoder, said mode being either a frame coding mode or a field coding mode.

17. The encoder of claim 16, wherein for each successive picture in said stream:
said encoder encodes each successive picture as a frame and as a first field and a second field resulting in an encoded frame and an encoded first field and an encoded second field;
said encoder replaces contents of a reference position n (mref[n]) of said frame buffer with contents of a reference position n-1 (mref[n-1]) of said frame buffer;
said encoder stores said encoded frame in a reference position 0 (mref[0]) of said frame buffer;
said encoder replaces contents of mref[n] of said field buffer with contents of mref[n-1] of said field buffer after said encoding of said first field and before said encoding of said second field;
said encoder stores said encoded first field in mref[0] of said field buffer;
said encoder replaces said contents of mref[n] of said field buffer with said contents of mref[n-1] of said field buffer after said encoding of said second field;
said encoder stores said encoded second field in mref[0] of said field buffer;
said encoder determines a next picture encoding mode if another picture in said stream of pictures is to be encoded, said next picture encoding mode being either a frame coding mode or a field coding mode;
said encoder replaces said encoded frame in mref[0] of said frame buffer with a reconstructed frame that is reconstructed from said encoded first field and said encoded second field if said next picture encoding mode is field coding mode; and
said encoder replaces said encoded first field in a reference position 1 (mref[1]) of said field buffer with a reconstructed first field and replacing said encoded second field of mref[0] of said field buffer with a reconstructed second field, said reconstructed first and second fields being reconstructed from said encoded frame if said next picture encoding mode is frame coding mode.

18. The encoder of claim 17, wherein said first field comprises a top field and said second field comprises a bottom field.

19. The encoder of claim 17, wherein said first field comprises a bottom field and said second field comprises a top field.

20. An encoder for adaptive frame/field encoding of digital video content using temporal prediction with motion compensation with multiple reference pictures, said digital video content comprising a stream of pictures which can each be intra, predicted, or bidirectionally interpolated pictures, said encoder comprising:
a frame buffer for storing said intra, predicted, or bidirectionally interpolated pictures that are encoded as frames, said pictures being used as reference pictures for other pictures in said stream that are to be encoded as frames; and
a field buffer for storing said intra, predicted, or bidirectionally interpolated pictures that are encoded as a first field and a second field, said pictures being used as reference pictures for other pictures in said stream that are to be encoded as a first field and a second field;
wherein said encoder manages and updates contents of said frame buffer and said field buffer in accordance with a mode of encoding that is selected before each picture in said stream of pictures is encoded by said encoder, said mode being either a frame coding mode or a field coding mode.

21. The encoder of claim 20, wherein for each successive picture in said stream:
said encoder replaces contents of a reference position n (mref[n]) of said frame buffer with contents of a reference position n-1 (mref[n-1]) of said frame buffer;
said encoder copies contents of an additional reference frame position (mref_P) of said frame buffer into a reference position 0 (mref[0]) of said frame buffer;
said encoder replaces contents of mref[n] of said field buffer with contents of mref[n-1] of said field buffer;
said encoder copies content of an additional reference top field position (mref_P_top) of said field buffer into mref[0] of said field buffer;
said encoder encodes each successive picture as a frame and as a first and a second field resulting in an encoded frame and an encoded first field and an encoded second field;
said encoder stores said encoded frame in mref_P of said frame buffer;
said encoder stores said encoded first field in mref_P_top of said field buffer;
said encoder replaces said contents of mref[n] of said field buffer with said contents of mref[n-1] of said field buffer after said encoding of said first field and before said encoding of said second field;
said encoder copies content of an additional reference bottom field position (mref_P_bot) of said field buffer into mref[0] of said field buffer;
said encoder stores said encoded second field in mref_P_bot of said field buffer;
said encoder determines a next picture encoding mode if another picture in said stream of pictures is to be encoded, said next picture encoding mode being either a frame coding mode or a field coding mode;
said encoder replaces said content of mref_P of said frame buffer with a reconstructed frame that is reconstructed from said encoded first field and said encoded second field if said next picture encoding mode is field coding mode; and
said encoder replaces contents of mref[0] of said field buffer with a reconstructed first field, said reconstructed first field being reconstructed from said encoded frame if said next picture encoding mode is frame coding mode; and
said encoder replaces said contents of mref_P_top and mref_P_bot, respectively, with said reconstructed first field and a reconstructed second field, said reconstructed second field being reconstructed from said encoded frame if said next picture encoding mode is frame coding mode.

22. The encoder of claim 21, wherein said first field comprises a top field and said second field comprises a bottom field.

23. The encoder of claim 21, wherein said first field comprises a bottom field and said second field comprises a top field.

24. An encoder for adaptive frame/field encoding of digital video content using temporal prediction with motion compensation with multiple reference pictures, said digital video content comprising a stream of pictures which can each be intra, predicted, or bidirectionally interpolated pictures, said encoder comprising:
a frame buffer for storing said intra or predicted pictures that are encoded as frames, said intra or predicted pictures being used as reference pictures for other pictures in said stream that are to be encoded as frames; and
a field buffer for storing said intra or predicted pictures that are encoded as a first field and a second field, said intra or predicted pictures being used as reference pictures for other pictures in said stream that are to be encoded as a first field and a second field;
a B frame buffer for storing said bidirectionally interpolated pictures that are encoded as frames, said bidirectionally interpolated pictures being used as reference pictures for other bidirectionally interpolated pictures in said stream that are to be encoded as frames;
a B field buffer for storing said bidirectionally interpolated pictures that are encoded as fields, said bidirectionally interpolated pictures being used as reference pictures for other bidirectionally interpolated pictures in said stream that are to be encoded as frames;
wherein said encoder manages and updates contents of said frame buffer and said field buffer in accordance with a mode of encoding that is selected before each picture in said stream of pictures is encoded by said encoder, said mode being either a frame coding mode or a field coding mode.

25. The encoder of claim 24, wherein for each successive intra or predicted picture in said stream:
said encoder replaces contents of a reference position n (mref[n]) of said frame buffer with contents of a reference position n-1 (mref[n-1]) of said frame buffer;
said encoder copies contents of an additional reference frame position (mref_P) of said frame buffer into a reference position 0 (mref[0]) of said frame buffer;
said encoder replaces contents of mref[n] of said field buffer with contents of mref[n-1] of said field buffer;
said encoder copies content of an additional reference top field position (mref_P_top) of said field buffer into mref[0] of said field buffer;
said encoder encodes each successive picture as a frame and as a first and a second field resulting in an encoded frame and an encoded first field and an encoded second field;
said encoder stores said encoded frame in mref_P of said frame buffer;
said encoder stores said encoded first field in mref_P_top of said field buffer;
said encoder replaces said contents of mref[n] of said field buffer with said contents of mref[n-1] of said field buffer after said encoding of said first field and before said encoding of said second field;
said encoder copies content of an additional reference bottom field position (mref_P_bot) of said field buffer into mref[0] of said field buffer;
said encoder stores said encoded second field in mref_P_bot of said field buffer;
said encoder determines a next picture encoding mode if another picture in said stream of pictures is to be encoded, said next picture encoding mode being either a frame coding mode or a field coding mode;
said encoder replaces said content of mref_P of said frame buffer with a reconstructed frame that is reconstructed from said encoded first field and said encoded second field if said next picture encoding mode is field coding mode; and
said encoder replaces contents of mref[0] of said field buffer with a reconstructed first field, said reconstructed first field being reconstructed from said encoded frame if said next picture encoding mode is frame coding mode; and
said encoder replaces said contents of mref_P_top and mref_P_bot, respectively, with said reconstructed first field and a reconstructed second field, said reconstructed second field being reconstructed from said encoded frame if said next picture encoding mode is frame coding mode.

26. The encoder of claim 24, wherein for each successive bidirectionally interpolated picture in said stream:
said encoder replaces contents of a reference position n (mref[n]) of said B frame buffer with contents of a reference position n-1 (mref[n-1]) of said B frame buffer;
said encoder copies contents of an additional reference frame position (mref_P) of said B frame buffer into a reference position 0 (mref[0]) of said B frame buffer;
said encoder replaces contents of mref[n] of said B field buffer with contents of mref[n-1] of said B field buffer;
said encoder copies content of an additional reference top field position (mref_P_top) of said B field buffer into mref[0] of said B field buffer;
said encoder encodes each successive picture as a frame and as a first and a second field resulting in an encoded frame and an encoded first field and an encoded second field;
said encoder stores said encoded frame in mref_P of said B frame buffer;
said encoder stores said encoded first field in mref_P_top of said B field buffer;
said encoder replaces said contents of mref[n] of said B field buffer with said contents of mref[n-1] of said B field buffer after said encoding of said first field and before said encoding of said second field;
said encoder copies content of an additional reference bottom field position (mref_P_bot) of said B field buffer into mref[0] of said B field buffer;
said encoder stores said encoded second field in mref_P_bot of said B field buffer;
said encoder determines a next picture encoding mode if another picture in said stream of pictures is to be encoded, said next picture encoding mode being either a frame coding mode or a field coding mode;
said encoder replaces said content of mref_P of said B frame buffer with a reconstructed frame that is reconstructed from said encoded first field and said encoded second field if said next picture encoding mode is field coding mode; and
said encoder replaces contents of mref[0] of said B field buffer with a reconstructed first field, said reconstructed first field being reconstructed from said encoded frame if said next picture encoding mode is frame coding mode; and
said encoder replaces said contents of mref_P_top and mref_P_bot, respectively, with said reconstructed first field and a reconstructed second field, said reconstructed second field being reconstructed from said encoded frame if said next picture encoding mode is frame coding mode.

27. The encoder of claim 25, wherein said first field comprises a top field and said second field comprises a bottom field.

28. The encoder of claim 25, wherein said first field comprises a bottom field and said second field comprises a top field.

29. The encoder of claim 26, wherein said first field comprises a top field and said second field comprises a bottom field.

30. The encoder of claim 26, wherein said first field comprises a bottom field and said second field comprises a top field.

31. An encoding system for adaptive frame/field encoding of digital video content using temporal prediction with motion compensation with multiple reference pictures, said digital video content comprising a stream of pictures which can each be intra or predicted pictures, said system comprising, for each successive picture in said stream:
means for storing each successive picture that is encoded as a frame in a frame buffer and each successive picture that is encoded as a first field and a second field in a field buffer; and
means for managing and updating contents of said frame buffer and said field buffer in accordance with a mode of encoding that is selected before each picture in said stream of pictures is encoded, said mode being either a frame coding mode or a field coding mode.

32. The system of claim 31, further comprising:
means for encoding each successive picture as a frame and as said first and said second fields resulting in an encoded frame and an encoded first field and an encoded second field;
means for replacing contents of a reference position n (mref[n]) of said frame buffer with contents of a reference position n-1 (mref[n-1]) of said frame buffer, said contents comprising reference frames;
means for storing said encoded frame in a reference position 0 (mref[0]) of said frame buffer;
replacing contents of mref[n] of said field buffer with contents of mref[n-1] of said field buffer after said encoding of said first field and before said encoding of said second field, said contents comprising reference fields;
means for storing said encoded first field in mref[0] of said field buffer;
means for replacing said contents of mref[n] of said field buffer with said contents of mref[n-1] of said field buffer after said encoding of said second field;
means for storing said encoded second field in mref[0] of said field buffer;
means for determining a next picture encoding mode if another picture in said stream of pictures is to be encoded, said next picture encoding mode being either said frame coding mode or said field coding mode;
means for replacing said encoded frame in mref[0] of said frame buffer with a reconstructed frame that is reconstructed from said encoded first field and said encoded second field if said next picture encoding mode is said field coding mode; and
means for replacing said encoded first field in a reference position 1 (mref[1]) of said field buffer with a reconstructed first field and replacing said encoded second field of mref[0] of said field buffer with a reconstructed second field, said reconstructed first and second fields being reconstructed from said encoded frame if said next picture encoding mode is said frame coding mode.

33. An encoding system for adaptive frame/field encoding of digital video content using temporal prediction with motion compensation with multiple reference pictures, said digital video content comprising a stream of pictures which can each be intra, predicted, or bidirectionally interpolated pictures, said system comprising, for each successive picture in said stream:
means for storing each successive picture that is encoded as a frame in a frame buffer and each successive picture that is encoded as a first field and a second field in a field buffer; and
means for managing and updating contents of said frame buffer and said field buffer in accordance with a mode of encoding that is selected before each picture in said stream of pictures is encoded, said mode being either a frame coding mode or a field coding mode;
wherein said bidirectionally interpolated pictures that are stored in said frame buffer and said field buffer are used as reference pictures for only other bidirectionally interpolated pictures that are to be encoded.

34. The system of claim 33, further comprising:
means for replacing contents of a reference position n (mref[n]) of said frame buffer with contents of a reference position n-1 (mref[n-1]) of said frame buffer;
means for copying content of a reference position (mref_P) of said frame buffer into a reference position 0 (mref[0]) of said frame buffer;
means for replacing contents of mref[n] of said field buffer with contents of mref[n-1] of said field buffer;
means for copying content of a reference field position (mref_P_top) of said field buffer into mref[0] of said field buffer;
means for encoding each successive intra or predicted picture as a frame and as a first and a second field resulting in an encoded frame and an encoded first field and an encoded second field;
means for storing said encoded frame in mref_P of said frame buffer;
means for storing said encoded first field in mref_P_top of said field buffer;
means for replacing said contents of mref[n] of said field buffer with said contents of mref[n-1] of said field buffer after said encoding of said first field and before said encoding of said second field;
means for copying content of a reference field position (mref_P_bot) of said field buffer into mref[0] of said field buffer;
means for storing said encoded second field in mref_P_bot of said field buffer;
means for determining a next picture encoding mode if another picture in said stream of pictures is to be encoded, said next picture encoding mode being either a frame coding mode or a field coding mode;
means for replacing said content of mref_P of said frame buffer with a reconstructed frame that is reconstructed from said encoded first field and said encoded second field if said next picture encoding mode is said field coding mode; and
means for replacing content of mref[0] of said field buffer with a reconstructed first field, said reconstructed first field being reconstructed from said encoded frame if said next picture encoding mode is said frame coding mode; and
means for replacing said contents of mref_P_top and mref_P_bot, respectively, with said reconstructed first field and a reconstructed second field, said reconstructed second field being reconstructed from said encoded frame if said next picture encoding mode is said frame coding mode.

35. An encoding system for adaptive frame/field encoding of digital video content using temporal prediction with motion compensation with multiple reference pictures, said digital video content comprising a stream of pictures which can each be intra, predicted, or bidirectionally interpolated pictures, said system comprising, for each successive picture in said stream:
means for storing each successive intra or predicted picture that is encoded as a frame in a frame buffer and each successive intra or predicted picture that is encoded as a first field and a second field in a field buffer;
means for storing each successive bidirectionally interpolated picture that is encoded as a frame in a B frame buffer and each bidirectionally interpolated picture that is encoded as a first field and a second field in a B field buffer; and
means for managing and updating contents of said frame buffer and said field buffer in accordance with a mode of encoding that is selected before each picture in said stream of pictures is encoded, said mode being either a frame coding mode or a field coding mode;
wherein said bidirectionally interpolated pictures that are stored in said B frame buffer and said B field buffer are used as reference pictures for only other bidirectionally interpolated pictures that are to be encoded.

36. The system of claim 35, further comprising:
means for replacing contents of a reference position n (mref[n]) of said frame buffer with contents of a reference position n-1 (mref[n-1]) of said frame buffer;
means for copying content of a reference position (mref_P) of said frame buffer into a reference position 0 (mref[0]) of said frame buffer;
means for replacing contents of mref[n] of said field buffer with contents of mref[n-1] of said field buffer;
means for copying content of a reference field position (mref_P_top) of said field buffer into mref[0] of said field buffer;
means for encoding each successive intra or predicted picture as a frame and as a first and a second field resulting in an encoded frame and an encoded first field and an encoded second field;
means for storing said encoded frame in mref_P of said frame buffer;
means for storing said encoded first field in mref_P_top of said field buffer;
means for replacing said contents of mref[n] of said field buffer with said contents of mref[n-1] of said field buffer after said encoding of said first field and before said encoding of said second field;
means for copying content of a reference field position (mref_P_bot) of said field buffer into mref[0] of said field buffer;
means for storing said encoded second field in mref_P_bot of said field buffer;
means for determining a next picture encoding mode if another picture in said stream of pictures is to be encoded, said next picture encoding mode being either a frame coding mode or a field coding mode;
means for replacing said content of mref_P of said frame buffer with a reconstructed frame that is reconstructed from said encoded first field and said encoded second field if said next picture encoding mode is said field coding mode; and
means for replacing content of mref[0] of said field buffer with a reconstructed first field, said reconstructed first field being reconstructed from said encoded frame if said next picture encoding mode is said frame coding mode; and
means for replacing said contents of mref_P_top and mref_P_bot, respectively, with said reconstructed first field and a reconstructed second field, said reconstructed second field being reconstructed from said encoded frame if said next picture encoding mode is said frame coding mode.

37. The system of claim 35, further comprising:
means for replacing contents of a reference position n (mref[n]) of said B frame buffer with contents of a reference position n-1 (mref[n-1]) of said B frame buffer;
means for copying content of a reference position (mref_P) of said B frame buffer into a reference position 0 (mref[0]) of said B frame buffer;
means for replacing contents of mref[n] of said B field buffer with contents of mref[n-1] of said B field buffer;
means for copying content of a reference field position (mref_P_top) of said B field buffer into mref[0] of said B field buffer;
means for encoding each successive intra or predicted picture as a frame and as a first and a second field resulting in an encoded frame and an encoded first field and an encoded second field;
means for storing said encoded frame in mref_P of said B frame buffer;
means for storing said encoded first field in mref_P_top of said B field buffer;
means for replacing said contents of mref[n] of said B field buffer with said contents of mref[n-1] of said B field buffer after said encoding of said first field and before said encoding of said second field;
means for copying content of a reference field position (mref_P_bot) of said B field buffer into mref[0] of said B field buffer;
means for storing said encoded second field in mref_P_bot of said B field buffer;
means for determining a next picture encoding mode if another picture in said stream of pictures is to be encoded, said next picture encoding mode being either a frame coding mode or a field coding mode;
means for replacing said content of mref_P of said B frame buffer with a reconstructed frame that is reconstructed from said encoded first field and said encoded second field if said next picture encoding mode is said field coding mode; and
means for replacing content of mref[0] of said B field buffer with a reconstructed first field, said reconstructed first field being reconstructed from said encoded frame if said next picture encoding mode is said frame coding mode; and
means for replacing said contents of mref_P_top and mref_P_bot, respectively, with said reconstructed first field and a reconstructed second field, said reconstructed second field being reconstructed from said encoded frame if said next picture encoding mode is said frame coding mode.
